(19) United States
(12) Patent Application Publication
(10) Pub. No.: US 2003/0037877 A1
(43) Pub. Date: Feb. 27, 2003

(54) Delabelling method and device for carrying out said method

(76) Inventor: Fritz Brinkmann, Rettenbach (DE)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/130,176

(22) PCT Filed: Aug. 19, 2001
(86) PCT No.: PCT/EP01/09955

(51) Int. Cl. B32B 1/00

(52) U.S. Cl. 156/344; 156/584

(57) ABSTRACT

The invention relates to a method for detaching or removing labels from a label substrate which adhere with a specific adhesive force to a label substrate, especially to a bottle case, specifically to the lateral surfaces of a bottle case, wherein

a tear-resistant sealable ribbon, preferably narrower than the label, is applied by its front side to the free visible side of the label opposite the label substrate,

the ribbon is integrally bonded to the label with a releasing force effective between label and ribbon, the effective releasing force between label and ribbon being greater than the adhesive force of the label to the label substrate, and

the ribbon is removed along with the integrally bonded label from the label substrate.

The invention further relates to an associated device for implementing the method.

The invention relates to a method and a device for detaching or removing labels from a label substrate which adhere with specific adhesion to a label substrate, especially to a bottle case, specifically to the lateral surfaces of a bottle case; the invention thus relates to a label-removing method and related devices for use in areas and/or locations in which labels are to be removed from a randomly shaped—for example rectangular or round—label substrate; in general, the invention thus falls within the area of materials management.

Methods and devices of this type are based on the principle according to which a mechanical detaching or removal device in the form of a scraping device, gripping device, or the like removes the labels adhering to the label substrate, specifically to the four lateral surfaces of a bottle case.

This approach does preclude the fact that a mechanical action is exerted not only on the label itself but also on the label substrate, and thus damage or at least visual degradation of the surface of the label substrate is unavoidable due to the fact that sharp and/or pointed instruments must be frequently employed to effectively and completely detach the labels.

In the example given for (the lateral surfaces of) bottle cases as label substrates, the use of this type of mechanical detaching or removal device not infrequently results in damage such as scratches, splintering, or the like on the bottle cases, thus rendering these unusable or at least hazardous at the damaged locations after only a few cycles.

In addition, the conventional methods and devices not infrequently succeed in only partially detaching or removing the labels from the label substrate, for example due to the fact that the scraping device, gripping device or the like grasps the label only partially, or scores or tears the label under the mechanical action effected by the scraping device, gripping device or the like—with the wholly undesirable result that an unattractive old label remnant remains which impedes or even interrupts any subsequent re-labeling procedure.

Finally, with the conventional mechanical detachment and removal devices, the disposal problem remains largely unresolved in which the labels usually flap loosely about after removal and consequently are usually not compatible with proper disposal in connection with environmentally appropriate recycling; in light of the increasingly important principle of environmental protection, this aspect is no longer appropriate.

In light of the disadvantages and inadequacies outlined above, the goal of the invention is therefore to provide a method and a device of the type referred to at the outset in which the label substrate for label removal is in no way degraded by the procedure, specifically is not damaged or otherwise impaired; an additional goal of the invention is to remove the labels for detachment or removal entirely from the label substrate such that no impeding pieces, remnants, or “shreds” of the label remain on the label substrate; the final goal of the invention is to solve the problem of disposing of the detached or removed labels in a cost-effective and environmentally compatible way even when the label is wet and/or highly soiled.

This goal is achieved according to the invention by a method and by a device according to the invention of the type referred to at the outset having the distinguishing features of the characterizing portion of claims 1 and 20.

The teaching of the invention thus provides for a tear-resistant ribbon, the front side of which is transported by a ribbon roll, preferably at a acute angle, to the free visible side of the label opposite the label substrate; in this context, the term “label substrate” refers within the scope of the invention to any object from which labels are to be removed.

Since the releasing force effective between the visible side of the label and the front side of the ribbon is greater due to the integral bond, such as a sealing bond, than the adhesive force between the side of the label facing the label substrate and the label substrate, the label is detached or removed from the label substrate as soon as the ribbon for subsequent disposal, together with the detached or removed labels which have, for example, been bonded to it by sealing, moves away from the label substrate and is wound onto a take-up roll—this process occurring even if the label is wet and/or highly soiled.

The take-up roll formed here from the disposable labels detached or removed from the label substrate and integrally bonded with the ribbon is a new (end-) product which is immediately produced by the method according to the invention.

Advantageous embodiments and useful modifications of the invention are characterized in the relevant dependent claims.

In one especially advantageous modification of the invention, at least one adhesion promoter is applied, before the integral bonding of the ribbon to the label, at least on a spot basis, specifically on a spot basis and/or regionally and/or in strips and/or over the entire surface, to the front side of the ribbon and/or to the free visible side of the label opposite the label substrate.

The result is an especially complete material-integrated bonding of the ribbon with the label for detachment or removal, the “material” here being the adhesion promoter, specifically at least one preferably liquid adhesive-based bonding means, specifically at least one acrylate-based adhesive and/or at least one copolymer-based adhesive and/or at least one cold-setting adhesive and/or at least one thermosetting adhesive (so-called hot-melt adhesive).

In order to create an especially intimate and highly effective bond between the label for detachment or removal and the ribbon, it is useful to apply the adhesion promoter shortly before, or immediately before the integral bonding of the ribbon with the label, especially by spraying it on or injecting it.

With respect to the location, specifically the application by spraying or injection of the adhesion promoter, an individual skilled in the art will also appreciate that the releasing force effective between the label and the ribbon may be adjusted and set according to the specific requirements.

The invention finally relates to the use of a specifically strip-type substrate material in the form of a ribbon which remains after attachment of labels to a label substrate, especially to a bottle case, specifically to the lateral surfaces of a bottle case, according to the type and/or with a device of the type described above.

The result is a synergistic approach in which the process of reattaching labels to a label substrate, especially to a bottle case, specifically to the lateral surfaces of a bottle case, is combined with the process of detaching or removal of labels from the label substrate, the labels exhibiting a given adhesive force to the label substrate, especially to a bottle case, specifically to the lateral surfaces of a bottle case:

In the first-named dispensing process, the usually strip-type substrate material or substrate ribbon for the labels remains, which material or ribbon may be utilized immediately after the dispensing process as the ribbon in the last-named detachment or removal process; the result of this approach is that first of all the creation of unnecessary waste is avoided, and secondly valuable resources and expensive raw materials are saved.

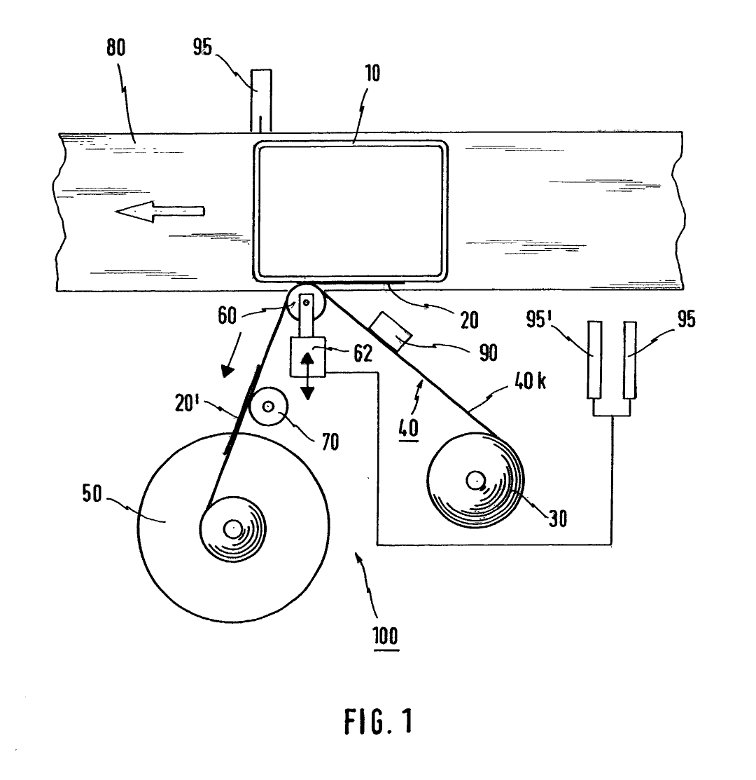

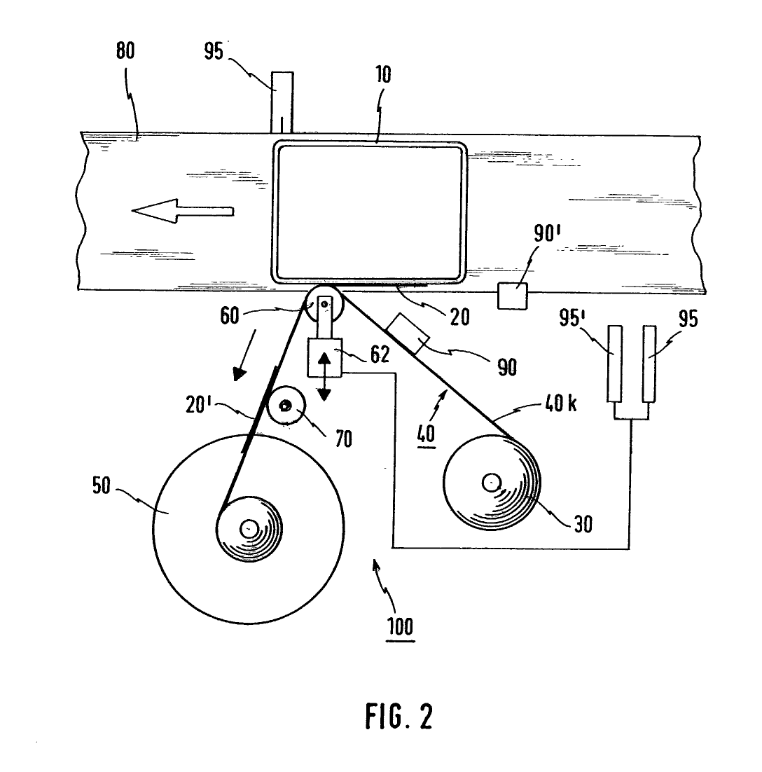

Additional modifications, features, and advantages of the invention are described below with reference to FIGS. 1 and 2, on the basis of which two sample embodiments of the invention for implementing the above-outlined method are explained in more detail with reference to the drawings.

FIG. 1 is a schematic view of a first embodiment of a device for detaching or removing labels from a label substrate according to the invention.

FIG. 2 is a schematic view of a second embodiment of the invention for detaching or removing labels from a label substrate according to the invention.

In FIGS. 1 and 2, identical reference numbers refer to the same or similarly designed elements or features.

FIGS. 1 and 2 show two embodiments of a device 100 for detaching or removing labels 20 adhering with a given adhesive force to the four lateral surfaces of a bottle case 10, hereinafter generally referenced as the “label substrate.” Label substrate 10 is conveyed here on a conveyor belt 80 in the direction of the arrow to the detachment or removal site of label 20.

Device 100 has a tear-resistant ribbon 40 to be applied, with a releasing force greater that the adhesion between label 20 and label substrate 10, from its front side 40k to the free visible side of the label opposite label substrate 10, the ribbon serving to detach or remove, from label substrate 10, label 20′ which is sealed onto front side 40k of ribbon 40 in FIG. 1.

Ribbon 40 here is designed to be slightly narrower than label 20 in order to reliably prevent any potential adherence of front side 40k of ribbon 40 to label substrate 10 which might impede the proper functioning of device 100; there is thus no contact whatever between label substrate 10 and the front side 40k of ribbon 40.

The two embodiments of FIGS. 1 and 2 both have a ribbon roll 30 for feeding ribbon 40 onto label substrate 10 at an angle of approximately 45°; in addition, in the two embodiments of FIGS. 1 and 2, a take-up roll 50 is provided for winding up ribbon 40 for disposal along with integrally bonded labels 20′ detached or removed from label substrate 10.

The take-up roll 50 for disposal formed here from ribbon 40 being integrally bonded to labels 20′ detached or removed from label substrate 10 is in fact a new (end)-product which is created directly according to the method of the invention.

In order to ensure, in the two embodiments of FIGS. 1 and 2, that ribbon 40 is always guided away at essentially the same angle from respective label substrate 10 along with integrally bonded label 20′ detached or removed from label substrate 10 regardless of the quantity of ribbon 40 already wound onto take-up roll 50, and thus, regardless of the given diameter of take-up roll 50, ribbon 40 is diverted by a deflecting roller 70 in the region between sealing roller 60 and take-up roll 50, this deflecting roller 70 being designed to be appropriately movable and adaptable in its position.

In addition, device 100 has a sealing roller 60 for the movement or travel of ribbon 40 along label 20. In this connection, ribbon 40 is divertible at label substrate 10 by means of sealing roller 60 by approximately a right angle. Sealing roller 60 may also be designed as a contact roller which interacts with a supplementary sealing stamp.

An additional contact device 62 is associated with sealing roller 60. This contact device 62 also serves to effect parallel travel along the label 20 for detachment or removal so that label 20 on ribbon 40 located between label 20 and contact device 62 adheres more precisely to the front side 40k of the ribbon and is thus virtually “carried along” by ribbon 40.

In this process, conveyor belt 80 is either paused (“step method”) or label substrate 10 is moved on conveyor belt 80 (“dynamic method”); in both cases, however, sealing roller 60 and contact device 62 are pressed onto the visible side of label 20 and moved along label 20.

To achieve effective control of sealing roller 60 and contact device 62, these may be pressed onto the visible side of label 20 and moved along label 20 relative to a guide edge detected by a detecting/sensing device 95 in the form of a light barrier.

The last point at which sealing roller 60 and contact device 62, after detaching or removing label 20′, are again removable, that is, retractable from label substrate 10 is the end of label 20, this retraction distance ranging between approximately twenty and thirty millimeters.

In order absolutely to avoid a situation in which there is an overlap of labels 20′ detached or removed from label substrate 10 and integrally bonded on the front side 40k of ribbon 40, ribbon 40 is able to be conveyed a short free segment further on the order of approximately zero to five millimeters.

In connection with the above function, ribbon 40 in the embodiments of FIGS. 1 and 2 is allowed to pause in response to an electrooptical control (“intermittent mode”) until the next label 20, when adhering to next label substrate 10, is detached or removed—the purpose being to minimize wastage of ribbon 40.

To further facilitate the detachment or removal of label 20 from label substrate 10, the first embodiment of FIG. 1 provides for a heating element 90 which thermally activates ribbon 40 in the region between ribbon roll 30 and sealing roller 60 before ribbon 40 is applied to label 20, this despite the fact that heating does occur via the sealing tool.

On the other hand, in the second embodiment of FIG. 2 there are two application devices 90 or 90′ by means of which a liquid, adhesive-based bonding means is applied regionally to front side 40k of ribbon 40 (→application device 90 in the region between ribbon roll 30 and sealing roller 60) or to the free visible side of label 20 opposite label substrate 10 (→application device 90′ directly on conveyor belt 80 immediately before sealing roller 60), that is, the bonding means is sprayed on before ribbon 40 is integrally bonded to label 20. This feature ensures that the releasing force effective between label 20 and ribbon 40 is adjustable based on the bonding means.

The second embodiment of FIG. 2 is specifically distinguished by the fact that no new, specially prepared ribbon need be employed as ribbon 40; instead use is made of the strip-like substrate material remaining after application of labels 20 to label substrate 10.

In the case of a plurality of label substrates 10 from which labels are to be removed, a situation may arise in which one or the other label substrate 10 is already without part of its label as a result of label 20 having prematurely detached from label substrate 10; in this case, a detection device 95′ in the form of a light barrier is placed in front through which the presence of a detachable or removable label 20 on label substrate 10 is detectable or monitorable.

With reference to the two embodiments of device 100 illustrated in FIGS. 1 and 2, a final feature fundamental to the invention is the fact that the label 20 for detachment or removal is stabilized by the bond between label 20 and ribbon 40, the releasing force having been transferred from ribbon 40—unless there has been a partial detachment and/or at least a partial tearing of label 20.

1. Method for detaching or removing labels (20) from a label substrate (10) adhering with a specific adhesion to a label substrate (10), especially to a bottle case, specifically to the lateral surfaces of a bottle case,
characterized in
that a tear-resistant, sealable ribbon (40), preferably slightly narrower than the label (20), is applied from its front side (40k) to the free, visible side of the label (20) opposite the label substrate (10),
that the ribbon (40) is integrally bonded to the label (20) with a releasing force effective between label (20) and ribbon (40), the releasing force effective between label (20) and ribbon (40) being greater than the adhesive force of the label (20) to the label substrate (10), and
that the ribbon (40) is removed from the label substrate (10) along with the integrally bonded label (20′).

2. Method according to claim 1, characterized in that the ribbon (40) is wound up along with the labels (20′) detached or removed from the label substrate (10) and integrally bonded to said ribbon, thereby creating a disposable take-up roll (50) formed from the ribbon (40) and the labels (20′) detached or removed from the label substrate (10) and integrally bonded to said ribbon.

3. Method according to claims 1 or 2, characterized in that the ribbon (40) is integrally bonded to the label (20) by sealing and/or by laser welding and/or by plasma welding and/or by ultrasonic welding.

4. Method according to at least one of claims 1 through 3, characterized in that the ribbon (40)
is fed at a acute angle onto the label substrate (10),
is diverted at the label substrate (10) by at least one sealing roller (60), specifically one moving along the label (20), and
is finally wound up as the disposable take-up roll (50) formed from the ribbon (40) and the sealed-on labels (20′) detached or removed from the label substrate (10).

5. Method according to claim 4, characterized in that the ribbon (40) is diverted at the label substrate (10) by approximately a right angle.

6. Method according to claims 4 or 5, characterized in that the ribbon (40) is diverted in the region between sealing roller (60) and take-up roll (50) by at least one deflecting roller (70).

7. Method according to at least one of claims 4 through 6, characterized in that at least one additional contact device (62), specifically in the form of at least one brush and/or in the form of at least one roller, is associated with, specifically placed after, the sealing roller (60).

8. Method according to at least one of claims 4 through 7, characterized in
that the label substrate (10) is conveyed on at least one conveyor belt (80),
that the sealing roll (60) and/or the contact device (62) is moved along the label (20) and pressed onto the visible side of the label (20) relative to a guide edge detected specifically by at least one detecting/sensing device (95), for example by at least one light barrier, the label substrate (10) being moved on the conveyor belt (80), or the conveyor belt (80) being paused,
that the last point at which the sealing roller (60) is retracted is the end of the label (20).

9. Method according to at least one of claims 1 through 8, characterized in that the ribbon (40) is preferably conveyed a short free segment further after detachment or removal of the label (20′).

10. Method according to at least one of claims 1 through 9, characterized in that the sealing roller (60) and/or the contact device (62) is moved away, preferably retracted, from the label substrate (10) after detachment or removal of the label (20′), specifically by a retraction distance on the order of approximately twenty millimeters to approximately thirty millimeters.

11. Method according to at least one of claims 1 through 10, characterized in that the ribbon (40) is paused by at least one electric and/or electronic and/or optical control until the next label (20) which may adhere to the next label substrate (10) has been detached or removed.

12. Method according to at least one of claims 1 through 11, characterized in that the ribbon (40) or label (20) is thermally activated or thermally pretreated by at least one heating element (90 or 90′) before the ribbon (40) is applied to the label (20).

13. Method according to at least one of claims 1 through 12, characterized by the preliminary step of detecting or monitoring the presence of label (20) for detachment or removal on the label substrate (10), specifically by a detection device (95′), for example by at least one light barrier.

14. Method according to at least one of claims 1 through 13, characterized in
that the label (20) for detachment or removal is stabilized by bonding label (20) and ribbon (40), and/or
that the releasing force is acquired from the ribbon (40)—unless there has been a partial detachment and/or at least a partial tearing of label (20).

15. Method according to at least one of claims 1 through 14, characterized in that, before the integral bonding of the ribbon (40) with the label (20), at least one adhesion promoter, especially at least one adhesive-based bonding means, specifically at least one acrylate-based adhesive and/or at least one copolymer-based adhesive and/or at least one cold adhesive and/or at least one thermally active adhesive (so-called hot-melt adhesive), is applied, at least on a spot basis to the front side (40k) of the ribbon (40) and/or to the free visible side of the label (20) opposite the label substrate (10).

16. Method according to claim 15, characterized in that the adhesion promoter is applied shortly or immediately before the integral bonding of the ribbon (40) to the label (20).

17. Method according to claims 15 or 16, characterized in that the adhesion promoter is applied on a spot basis and/or regionally and/or in strips and/or over the entire surface, to the front side (40k) of the ribbon (40) and/or to the free visible side of the label (20) opposite the label substrate (10).

18. Method according to at least one of claims 15 through 17, characterized in that the adhesion promoter is sprayed on or injected.

19. Method according to at least one of claims 15 through 18, characterized in that the releasing force effective between label (20) and ribbon (40) is adjusted by the adhesion promoter.

20. Device (100) for detaching or removing labels (20) adhering with a specific adhesive force to a label substrate (10), especially to a bottle case, specifically to the lateral surfaces of a bottle case, from the label substrate (10); and for implementing the method according to at least one of claims 1 through 19,
characterized by
a tear-resistant ribbon to be applied by its front side (40k) to the free visible side of the label (20) opposite the label substrate (10) and having a releasing force effective between label (20) and ribbon (40) which is greater that the adhesion between the label (20) and the label substrate (10), said ribbon serving to detach or remove the label (20′) from the label substrate (10), which label has been integrally bonded on the front side (40k) of the ribbon (40), specifically sealed on;
a ribbon roll (30) for feeding the ribbon (40) onto the label substrate (10), preferably at an acute angle;
a take-up roll (50) for winding up the disposal ribbon (40) along with the labels (20′) integrally bonded to it which have been detached or removed from the label substrate (10).

21. Device according to claim 20, characterized in that the site of the integral bond between the label (20) and the ribbon (40) is not larger than the label (20).

22. Device according to claims 20 or 21, characterized in that at least one sealing roller (60) is provided for the movement or travel of the ribbon (40) along the label (20).

23. Device according to claim 22, characterized in that the ribbon (40) is divertible at the label substrate (10) by the sealing roller (60), specifically by approximately a right angle.

24. Device according to claim 22 or 23, characterized in that at least one deflecting roller (70) for diverting the disposal ribbon (40) along with the integrally bonded labels (20′) detached or removed from the label substrate (10) is located in the region between the sealing roller (60) and the take-up roll (50).

25. Device according to at least one of claims 20 through 24, characterized in that at least one additional contact device (62), specifically in the form of at least one brush and/or in the form of at least one roller is associated with, specifically placed after, the sealing roller (60).

26. Device according to at least one of claims 20 through 25, characterized in that the sealing roll (60) and/or the contact device (62) may be moved along the label (20) and may be pressed onto the visible side of the label (20) relative to a guide edge detected specifically by at least one detecting/sensing device (95), for example by at least one light barrier.

27. Device according to at least one of claims 20 through 26, characterized in that the last point at which the sealing roller (60) may be retracted is the end of the label (20).

28. Device according to at least one of claims 20 through 27, characterized in that the sealing roller (60) and/or the contact device (62) may be removed, preferably retracted, from the label substrate (10) after detachment or removal of the label (20′), specifically by a retraction distance on the order of approximately twenty millimeters to approximately thirty millimeters.

29. Device according to at least one of claims 20 through 28, characterized in that the ribbon (40) is able to be conveyed a preferably short free segment further on the order of approximately one millimeter to approximately 20 millimeters, specifically on the order of approximately two millimeters to approximately ten millimeters after detachment or removal of the label (20′).

30. Device according to at least one of claims 20 through 29, characterized in that at least one conveyor belt (80) is provided to convey the label substrate (10).

31. Device according to at least one of claims 20 through 30, characterized in that an electrical and/or electronic and/or optical control is provided to pause the ribbon (40) until the next label (20) which may adhere to the next label substrate (10) has been detached or removed.

32. Device according to claim 31, characterized in that the control is associated with the sealing roller (60) and/or the contact device (62).

33. Device according to at least one of claims 20 through 32, characterized in that at least one heating element (90 or 90′) is provided for the thermal activation of the ribbon (40) or for the thermal pretreatment of the label (20) before the ribbon (40) is applied to the label (20).

34. Device according to claim 33, characterized in that the heating element (90) is located in the region between ribbon roll (30) and sealing roller (60).

35. Device according to at least one of claims 20 through 34, characterized in that at least one detection device (95′), for example at least one light barrier, is provided to detect or monitor the presence of a label (20) for detachment or removal.

36. Device according to claims 26 and 35, characterized in that
the detecting/sensing device (95) for detecting the guide edge and
the detection device (95′) for detecting or monitoring the presence of a label (20) for detachment or removal is of a unitary and/or a one-piece and/or an integrally mounted design.

37. Device according to at least one of claims 20 through 36, characterized in
that the label (20) for detachment or removal is stabilized by the bond between label (20) and ribbon (40) and/or
that the releasing force is transferred from ribbon (40), unless there has been a partial detachment and/or at least a partial tearing of label (20).

38. Device according to at least one of claims 20 through 37, characterized in that at least one application device (90 or 90′) is provided for the at least spot-based application of at least one adhesion promoter, especially at least one adhesive-based bonding means, specifically at least one acrylate-based adhesive and/or at least one copolymer-based adhesive and/or at least one cold adhesive and/or at least on thermally active adhesive (so-called hot-melt adhesive) to the front side (40k) of the ribbon (40) and/or to the free visible side of the label (20) opposite the label substrate (10) before the integral bonding of the ribbon (40) to the label (20).

39. Device according to claims 33 or 34 and according to claim 38, characterized in that the heating element (90 or 90′) and the application device (90 or 90′) are of a unitary and/or a one-piece and/or an integrally mounted design.

40. Device according to claims 38 or 39, characterized in that the application device (90 or 90′) is designed for the application of the adhesion promoter, on a spot basis and/or regionally and/or in strips and/or over the entire surface, to the front side (40k) of the ribbon (40) and/or to the free visible side of the label (20) opposite the label substrate (10).

41. Device according to at least one of claims 38 through 40, characterized in that the application device (90 or 90′) is designed for spraying on or injecting the adhesion promoter.

42. Device according to at least one of claims 38 through 41, characterized in that the releasing force effective between label (20) and ribbon (40) is adjustable by the adhesion promoter.

43. Use of a substrate material, specifically of a strip type, in the form of a ribbon (40) which remains on the label substrate (10), especially on a bottle case, specifically on the lateral surfaces of a bottle case after application of labels (20), said use being in connection with a method according to at least one of claims 1 through 19 and/or in connection with a device according to at least one of claims 20 through 42.
